(19) United States
(12) Patent Application Publication
(10) Pub. No.: US 2006/0212213 A1
(43) Pub. Date: Sep. 21, 2006

(54) Navigation System

(76) Inventor: Roman Piekarz, Mielec (PL)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/366,798

(22) Filed: Mar. 3, 2006

(30) Foreign Application Priority Data
Mar. 9, 2005 (DE) 10 2005 011 215.3

(51) Int. Cl. G01C 21/00

(52) U.S. Cl. 701/200; 701/207

(57) ABSTRACT

A navigation system (1) having a navigation system housing (2), which has an internal position-finding unit (9), a data memory (5) and/or a data memory reader unit (6), a display unit (3), an interface (7) to a separate voltage supply source, and a computation and control unit (4) for route guidance and control of the navigation system (1), has locking means (11), which are provided on the navigation system housing (2) for detachable connection of the navigation system housing (2) to a holder (10) which can be mounted in a motor vehicle. The holder (10) has a voltage supply connection (13), which can be connected to the voltage supply system in the motor vehicle, for connection to the interface (7) of the navigation system housing (2). For mobile operation, a separate battery housing (15) is provided, which is designed to hold batteries for the voltage supply for the navigation system (1) and has a voltage supply connection (18), which is provided for connection to the interface (7) on the navigation system housing (2), and has locking means (17) which interact with the locking means (11) on the navigation system housing (2), such that the navigation system (1) can be used in conjunction with the holder (10) as a stationary navigation system (1), and in conjunction with the battery housing (15) as a mobile, portable navigation system (1).

The invention relates to a navigation system having a navigation system housing, which has an internal position-finding unit, a data memory and/or a data memory reader unit, a display unit, an interface to a separate voltage supply source, and a computation and control unit for route guidance and control of the navigation system, with locking means being provided on the navigation system housing for detachable connection of the navigation system housing to a holder which can be mounted in a motor vehicle, and with the holder having a voltage supply connection, which can be connected to the voltage supply system in the motor vehicle, for connection to the interface of the navigation system housing.

Navigation systems for installation in motor vehicles are sufficiently well known. In the version that is intended for permanent installation, they have a central computation and control unit, which is connected via cables to an external display unit, that is to say to a display, and to a position-finding unit which is mounted on the vehicle, for example a GPS (Global Positioning System) receiver. A further connection can be provided to an audio system installed in the vehicle and, if required, to a mobile telephone system.

The installation of such permanently installed navigation systems is complex, so that they are generally fitted once in the new vehicle or are retrofitted once, and remain there. Furthermore, portable navigation systems are known, which are connected to an external position-finding module and can be connected via a charging cable to the voltage supply system in a motor vehicle. These navigation appliances may, for example, be clamped to the front windshield of a vehicle by means of a suction-cup holder.

A navigation system which is permanently installed in a vehicle is known from German Utility Model 203 08 939, in which the controller can be removed from the vehicle and has an interface for connection to an external evaluation and display unit, for example to a personal computer.

However, the change between mobile operation and operation in a motor vehicle still requires too much installation effort.

One object of the invention is thus to provide an improved navigation system which can be used both in a motor vehicle and in a mobile form for other purposes, and in which it is simple and quick to change between stationary motor-vehicle operation and mobile operation.

According to the invention, the object is achieved by the navigation system of this generic type in that a separate battery housing is provided, which is designed to hold batteries for the voltage supply for the navigation system with the battery housing having a voltage supply connection, which is provided for connection to the interface of the navigation system housing, and having locking means which interact with the locking means on the navigation system housing, such that the navigation system can be used in conjunction with the holder as a stationary navigation system, and in conjunction with the battery housing as a mobile, portable navigation system.

This results in a set in which the holder that is installed in the vehicle as well as the battery housing for its mobile operation have locking means which correspond with the locking means on the navigation system housing. The interface to the voltage supply ensures that the navigation system is supplied from the voltage supply system in the motor vehicle during operation in a motor vehicle, and is supplied from the batteries in the battery housing during mobile operation of the navigation system.

Since an internal position-finding unit is integrated in the navigation system housing, this makes it possible for the navigation system now to be used both in the motor vehicle and in a mobile form, without any further conversion work.

It is particularly advantageous if the computation and control unit is connected by means of an interface, which is arranged on the navigation system housing, to an external control unit. In this case, an external control unit is then arranged on the battery housing for connection to the interface when the battery housing is locked to the navigation system housing. This therefore results in a compact navigation system for mobile operation, which can be controlled by the user by means of the control unit which is arranged on the battery housing.

In contrast, an external remote control can be used for operation in a motor vehicle, which may be permanently installed in the motor vehicle and is either coupled via an interface in the holder to the interface for the control signals to the navigation system housing, or communicates without the use of wires, for example via an infrared or radio interface (for example based on the Bluetooth Standard) with the computation and control unit.

It is also advantageous if the computation and control unit is connected to an interface, which is arranged on the navigation system housing, for connection of an external position-finding device. This means that a position-finding unit which, for example, is permanently installed on the motor vehicle can be used in addition to the internal position-finding unit, which is integrated in the navigation system housing, in order to improve the reception of a position-finding signal for the navigation system. This external position-finding unit may, for example, be a satellite position-finding module, for example a GPS module, or else a mobile telephone for mobile radio network position finding.

It is particularly advantageous if the computation and control unit is designed for switching the connection of the computation and control unit with the internal position-finding unit to the external position-finding unit when it is found that an external position-finding unit has been connected. The external position-finding unit, which is generally more sensitive, is thus given priority for determination of the current position information.

The interface for connection of the external position-finding unit may be a standard connection, for example a USB connection. This interface can thus be used not only for connection of the external position-finding unit but also for programming of the navigation system, for example in order to update the software which is implemented in the navigation system in order to control the computation and control unit.

It is also advantageous if the computation and control unit is designed to switch the navigation system to a power-saving mode when it is found that the battery housing has been connected to the navigation system housing. The power-saving mode may, for example, comprise the position being determined at longer time intervals with the position-finding device being switched to a standby mode in the time between the position determination processes. The position is thus updated at longer time intervals during battery operation than during vehicle operation when a voltage supply system in a motor vehicle is connected by terminal in a navigation system.

The power-saving mode may alternatively or additionally comprise the brightness of the display unit being reduced, thus reducing the power consumption of the display on the display unit.

It is particularly advantageous if the battery housing has a broadcast radio signal antenna which can be connected to the navigation system or has a connection for such a broadcast radio signal antenna, and the navigation system is designed to evaluate traffic information which is transmitted by broadcast radio and can be received by means of the broadcast radio signal antenna and a receiving unit. The receiving unit can be installed either in the navigation system housing or in the battery housing. For example, the receiving unit may be part of the computation and control unit. The option for reception of broadcast radio signals and the extraction of traffic information from the broadcast radio signals, for example TMC (Traffic Message Channel) signals, makes it possible to take account of the traffic information, in particular jam messages, in the route guidance, as well.

It is particularly advantageous if at least one loudspeaker and/or headset connection, which are/is integrated in the navigation system housing and/or the battery housing are/is provided. In this case, the computation and control unit is designed to reproduce audio signals which can be read from the data memory, by the data memory reader unit from a separate data memory and/or can be received by an integrated broadcast radio receiving unit. Thus, in addition to route guidance, the navigation system can also be used to reproduce video and/or audio signals, that is to say as a music player. This is particularly advantageous for mobile operation, since the navigation system replaces a separate player, for example an MP3 player.

The computation and control unit is preferably designed to read navigation data with the data memory reader unit from a separate data memory and for temporary storage in the internal data memory. The computation and control unit is then provided, in addition to the navigation function, to read audio and/or video data with the data memory reader unit from a separate data memory and for reproduction of the audio and/or video data that has been read. This is made possible by the temporary storage of the navigation data, which is first of all read from a separate data memory with the data memory reader unit, so that the data memory reader unit is then available for a data memory containing audio and/or video data.

The at least one interface and the locking means are preferably arranged on the navigation system housing in such a way that, when the navigation system housing is locked to the holder or to the battery housing, an electrical connection is at the same time made by means of the at least one interface to a corresponding interface connection on the holder or on the battery housing. This avoids the need for complex reconnection of peripheral connections for the voltage supply, the position-finding unit, the control unit, etc.

The invention will be explained in more detail in the following text with reference, by way of example, to the attached drawings in which:

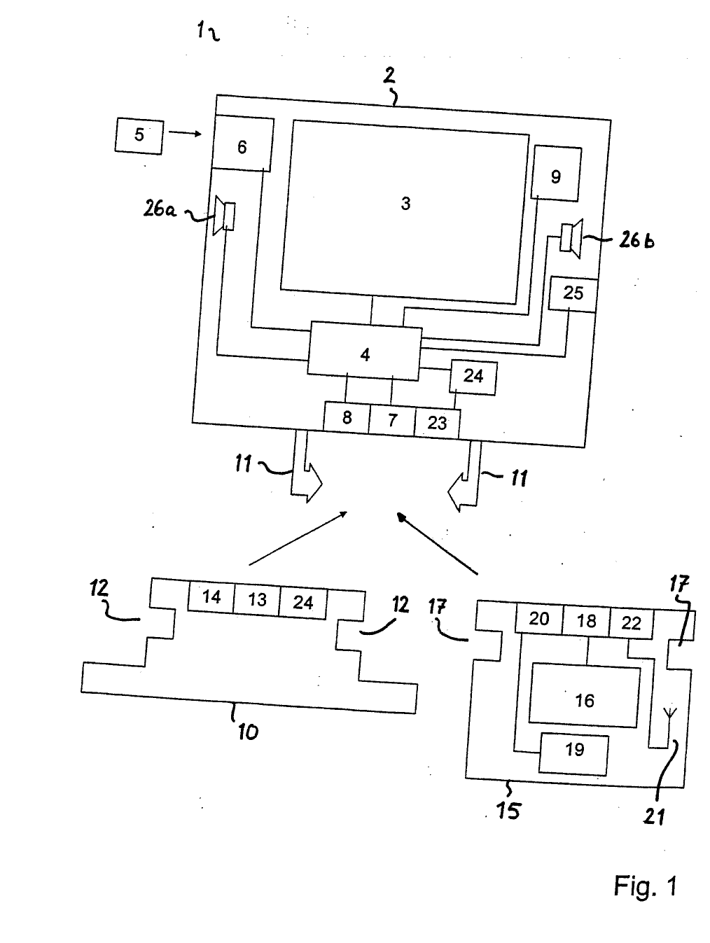

FIG. 1 shows a block diagram of a navigation system having a navigation system housing, as well as a separate holder and battery housing;

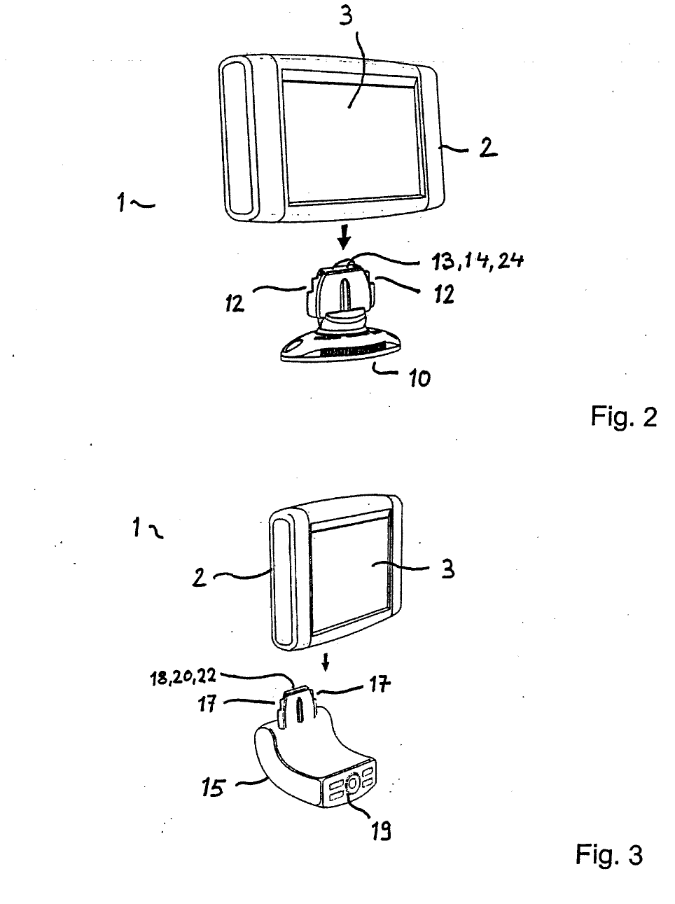

FIG. 2 shows a sketch of a navigation system having a navigation system housing which can be plugged onto a holder which is installed in a motor vehicle;

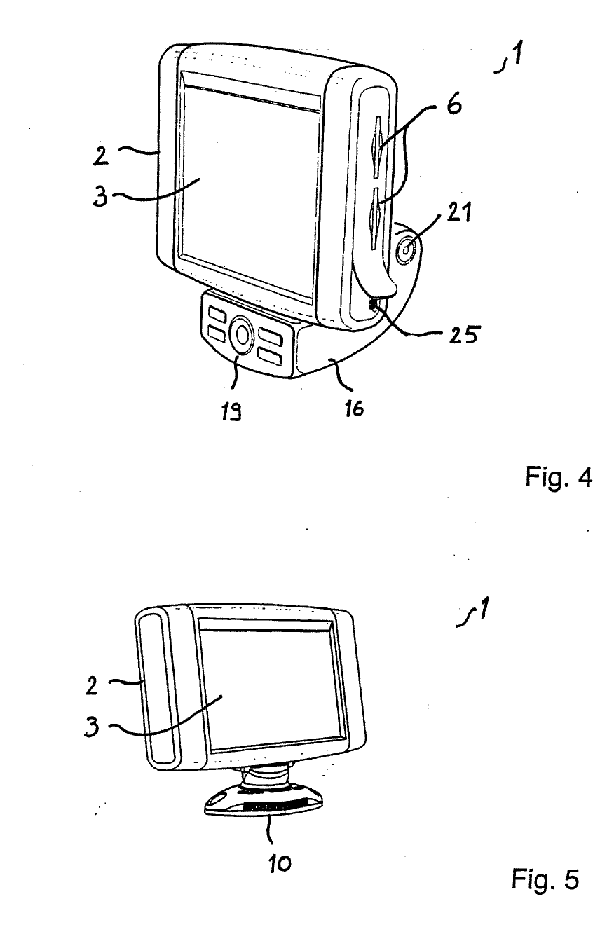

FIG. 3 shows a sketch of a navigation system having a battery housing which has been removed from the navigation system housing;

FIG. 4 shows a perspective illustration of a navigation system having a battery housing plugged onto it, for mobile operation;

FIG. 5 shows a perspective illustration of a navigation system having a navigation system housing, which can be plugged onto a permanently installed holder, for stationary operation;

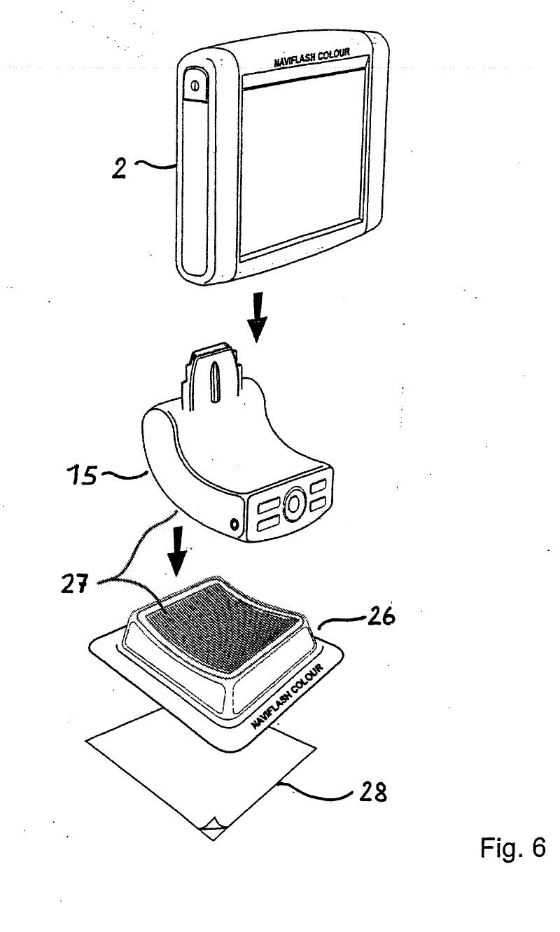

FIG. 6 shows a perspective illustration of a navigation system housing and of a battery housing, which can be fixed to a holder which can be permanently installed; and

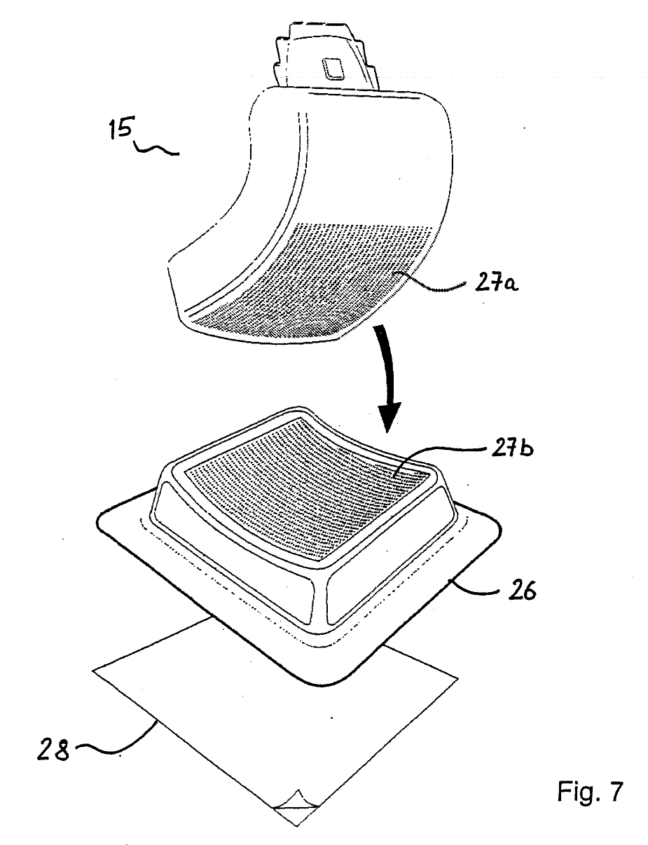

FIG. 7 shows a perspective illustration of the battery housing and of the holder from FIG. 6 with a Velcro fastener for detachable attachment of the battery housing to the holder.

FIG. 1 shows a block diagram of a navigation system 1 which essentially has a navigation system housing 2 with a display unit 3, that is to say a display, for displaying driving routes for route guidance. The navigation system 1 and the route calculation are controlled by a computation and control unit 4, which is connected to the display unit 3 in order to output the proposed route, possibly as well as map sections. For this purpose, the computation and control unit 4 preferably has a microprocessor, as well as suitable software. A data memory reader unit 6 is provided in order to read in navigation data, which is stored on a separate external data memory 5, and is connected to the computation and control unit. By way of example, a compact flash card is a suitable data memory 5. The data memory reader unit 6 is in the form of a suitable card reader.

The navigation system 1 is supplied externally with the necessary operating voltage via a voltage supply interface 7. Furthermore, a control interface 8 is provided, in order to make it possible to control the navigation system 1 using a separate, external control unit.

In order to determine the current position of the navigation system 1, an internal position-finding unit 9 is integrated in the navigation system housing 2, for example a satellite navigation receiver based on the GPS (Global Positioning System) Standard, or on the future Galileo Standard.

For operation in a motor vehicle, the navigation system housing can be plugged onto a holder 10 which is installed in the motor vehicle. In this case, locking means 11 are provided on the navigation system housing 2, and locking means 12 which interact with the locking means 11 are provided on the holder 10. Furthermore, corresponding voltage supply connections 13, possibly as well as connections 14 to a control unit which is not illustrated but is installed in the vehicle, are provided on the holder 10.

Plugging the navigation system housing 2 onto the holder 10 makes the navigation system 1 fully operable since, when it is plugged on, an electrical connection is at the same time made at least to the voltage supply system in the motor vehicle, and optionally to a control unit and/or a broadcast radio receiving antenna and/or external position-finding unit.

Furthermore, a separate battery housing 15 is provided for holding batteries 16 for mobile operation of the navigation system 1. The battery housing 15 likewise has locking means 17 which interact with the locking means 11 on the navigation system housing 2. These locking means are arranged with respect to a voltage supply connection 18 of the battery housing 15 such that, when the battery housing 15 is plugged onto the navigation system housing 2, a connection is made with the voltage supply interface 7 of the navigation system housing 2, and the navigation system 1 is thus supplied with electrical power via the battery 16.

Furthermore, a control unit 19 is installed in the battery housing 15 and is connected via a control keyboard connection 20 to the control unit interface 8 of the navigation system housing 2 when the battery housing 15 has been plugged onto the navigation system housing 2. The control unit 19 has an appropriate number of switches and/or keys for operation of the navigation system 1.

A broadcast radio signal antenna 21 or a connection for such an antenna can optionally also be installed in the battery housing 15, and can be connected via an antenna connection 22 to an antenna interface 23 on the navigation system housing. A receiver 24 which is connected to the antenna signal interface 23 is installed in the navigation system housing 2, by means of which a broadcast radio signal can be received and at least traffic information can be extracted from the broadcast radio signal, which can be evaluated by the computation and control unit 4 and can be taken into account for route guidance.

On the other hand, the holder 10 which is installed in the vehicle can likewise have an antenna connection 24 which is connected to the broadcast radio antenna that is normally installed in the vehicle.

Furthermore, a standard interface connection, for example a USB connection 25, is preferably integrated in the navigation system housing 2 and is connected to the computation and control unit 4. The USB connection can be provided for connection of an external position-finding device, for example a GPS position-finding module which is permanently mounted in the vehicle. As soon as the computation and control unit 4 finds that an external position-finding device such as this has been connected, the position determination process is switched from the internal position-finding device 9 to the external position-finding device. This has the advantage that external position-finding devices are generally more sensitive.

Furthermore, one, two or more loudspeakers 26a, 26b can be integrated in the navigation system housing, and are connected to the computation and control unit 4. In addition to route guidance, the loudspeakers 26 can also be used for reproduction of audio signals, for example for playing pieces of music. The audio data can be read from an external data storage medium by the data memory reader unit 6 and can be reproduced by a suitable configuration, in particular programming of the computation and control unit 4. In order to ensure operation of the navigation system 1 for route guidance at the same time, the navigation data can be stored in a buffer store, so that, once the navigation data has been read with the aid of the data memory reader unit 6, this is available for reading other data memories 5.

FIG. 2 shows a perspective view of the navigation system 1, when the navigation system housing 2 with the display unit 3 is plugged onto the holder 10 that is integrated in a vehicle. As can be seen, the voltage supply connection and, possibly, connections for the control unit 13, 14, 24, are integrated in the holder 10, so that this ensures that the navigation system 1 is fully operable once the navigation system housing 2 has been plugged onto the holder 10.

FIG. 3 shows a side view of the navigation system 1, with the battery housing 15 plugged onto the navigation system housing 2. As can be seen, the battery housing 15 is fixed to the navigation system housing 2 with the aid of spring-mounted hooks, as locking means 17. FIG. 6 shows a sketch of the battery housing 15. The voltage supply connections 18, the control element connections 20, the control elements 19 as well as the broadcast radio antenna 21 with the antenna connection 22 can be seen from the sketch.

FIG. 4 shows a sketch of a front view of the navigation system 1 for mobile operation by connection of the battery housing 15 to the navigation system housing 2. As can be seen, a control unit 19 with control keys is arranged on the front face of the battery housing 15. The broadcast radio signal antenna 21 can also be seen.

In contrast to this, FIG. 5 shows a perspective view of the navigation system 1, with the navigation system housing 2 having been plugged onto the holder 10, which is permanently installed in a vehicle, for quasi-stationary operation, and being supplied with voltage via a supply cable 27 to the power supply system in the vehicle.

FIG. 6 shows a perspective illustration of a navigation system housing 2 and of a battery housing 15. The illustration also shows a holder 26 which has attachment means 27, for example in the form of a part of a Velcro fastener, on its surface that is intended to hold the battery housing 15. The holder 26 can be fitted permanently. For this purpose, for example, a double-sided adhesive tape 28 can be provided on the lower face of the holder 26. Other attachment methods, such as a suction cup, magnetic attachment, etc., are feasible.

FIG. 7 shows a perspective illustration of the battery housing 15 and of the holder 26. As can be seen, the battery housing 15 has attachment means 27a in the form of the other part of the Velcro fastener, which interacts with the part 27b of the Velcro fastener on the holder 26. As can also be seen from FIG. 7, the surface of the holder 26 is matched to the curved surface of the battery housing, so that the battery housing 15 rests flat against the surface of the holder 26.

1. A navigation system (1) having a navigation system housing (2), which has an internal position-finding unit (9), a data memory (5) and/or a data memory reader unit (6), a display unit (3), an interface (7) to a separate voltage supply source, and a computation and control unit (4) for route guidance and control of the navigation system (1), with locking means (11) being provided on the navigation system housing (2) for detachable connection of the navigation system housing (2) to a holder (10) which can be mounted in a motor vehicle, and with the holder (10) having a voltage supply connection (13), which can be connected to the voltage supply system in the motor vehicle, for connection to the interface (7) of the navigation system housing (2), comprising a separate battery housing (15) which is designed to hold batteries for the voltage supply for the navigation system (1) with the battery housing (15) having a voltage supply connection (18), which is provided for connection to the interface (7) of the navigation system housing (2), and having locking means (17) which interact with the locking means (11) on the navigation system housing (2), such that the navigation system (1) can be used in conjunction with the holder (10) as a stationary navigation system (1), and in conjunction with the battery housing (15) as a mobile, portable navigation system (1)

2. The navigation system (1) as claimed in claim 1, wherein the computation and control unit (4) is connected by means of an interface (8), which is arranged on the navigation system housing (2), to an external control unit, and wherein an external control unit (19) is arranged on the battery housing (15) for connection to the interface (8) when the battery housing (15) is locked to the navigation system housing(2)

3. The navigation system (1) as claimed in claim 1, wherein the computation and control unit (4) has an interface (25), which is arranged on the navigation system housing (2), for connection of an external position-finding unit.

4. The navigation system (1) as claimed in claim 3, wherein the computation and control unit (4) is designed for switching the connection of the computation and control unit (4) with the internal position-finding unit (9) to the external position-finding unit when it is found that an external position-finding unit has been connected to the interface (25)

5. The navigation system (1) as claimed in claim 3, wherein the interface (25) for connection of the external position-finding device is a USB (Universal Serial Bus) connection.

6. The navigation system (1) as claimed in claim 1, wherein the computation and control unit (4) is designed to switch the navigation system (1) to a power-saving mode when it is found that the battery housing (15) has been connected to the navigation system housing (2).

7. The navigation system (1) as claimed in claim 6, wherein the power-saving mode comprises the position being determined at longer time intervals with the position-finding device (9) being switched to a standby mode in the time between the position determination processes.

8. The navigation system (1) as claimed in claim 6, wherein the power-saving mode comprises the brightness of the display unit (3) being reduced.

9. The navigation system (1) as claimed in claim 1, wherein the battery housing (15) has a broadcast radio signal antenna (21) which can be connected to the navigation system (1) or has a connection for a broadcast radio signal antenna (21), and the navigations system (1) is designed to evaluate traffic information which is transmitted by broadcast radio and can be received by means of the broadcast radio signal antenna (21) and a receiving unit (24).

10. The navigation system (1) as claimed in claim 1, comprising at least one loudspeaker (26) and/or headset connection which are/is integrated in the navigation system housing (2) and/or the battery housing (15) with the computation and control unit (4) being designed to reproduce video and/or audio signals which can be read from the data memory (5), by the data memory reader unit (6) from a separate data memory (5) and/or can be received by an integrated broadcast radio receiving unit (24).

11. The navigation system (1) as claimed in claim 10, wherein the computation and control unit (4) is designed to read navigation data with the data memory reader unit (6) from a separate data memory (5) and for temporary storage in the internal data memory, and, in addition to the navigation function, the computation and control unit (4) is provided to read audio and/or video data with the data memory reader unit (6) from a separate data memory (5) and for reproduction of the audio and/or video data that has been read.

12. The navigation system (1) as claimed in claim 1, wherein the at least one interface (7, 8, 23) and the locking means (11) are arranged on the navigation system housing (2) in such a way that, when the navigation system housing (2) is locked to the holder (10) or to the battery housing (15), an electrical connection is at the same time made by means of the at least one interface (7, 8, 23) to a corresponding interface connection (13, 14, 18, 20, 22, 24) on the holder (10) or on the battery housing (15)

13. The navigation system (1) as claimed in claim 1, wherein the battery housing (15) has attachment means (27) for detachable connection of the battery housing (15) to a holder (26) which can be fitted permanently.

14. The navigation system (1) as claimed in claim 13, wherein the attachment means (27) is in the form of a Velcro fastener.
